(19) United States
(12) Patent Application Publication
(10) Pub. No.: US 2013/0251851 A1
(43) Pub. Date: Sep. 26, 2013

(54) EGG WHITE HYDROLYSATE AND PRODUCTION METHOD THEREFOR

(71) Applicants: Kohei Watabe, Kunitachi-shi (JP); Taro Yamazaki, Kawasaki-shi (JP)

(72) Inventors: Kohei Watabe, Kunitachi-shi (JP); Taro Yamazaki, Kawasaki-shi (JP)

(73) Assignee: KEWPIE CORPORATION, Tokyo (JP)

(21) Appl. No.: 13/989,998

(22) PCT Filed: Aug. 24, 2011
(86) PCT No.: PCT/JP2011/069055

§ 371 Date: May 28, 2013

(30) Foreign Application Priority Data
Nov. 30, 2010 (JP) 2010-266423

(51) Int. Cl. A23L 1/32

(52) U.S. Cl. CPC A23L 1/3208
USPC 426/32; 426/614

(57) ABSTRACT

An egg white hydrolysate having a reduced sulfur smell characteristic to egg white and a production method therefor are provided. An egg white hydrolysate having a low hydrogen sulfide content and a reduced sulfur smell can be obtained through a pretreatment step of denaturing egg white by thermally treating a diluted egg white solution under conditions of a pH of 9 to 12 and a temperature of 55° C. to 90° C., the diluted egg white solution having been prepared by diluting 1 part of liquid egg white with 0.4 to 3 parts of water, and a step of performing hydrolysis with a protease.

### TECHNICAL FIELD

The present invention relates to an egg white hydrolysate having a reduced sulfur smell characteristic to egg white and to a method for producing the egg white hydrolysate that includes a pretreatment step of thermally denaturing a diluted egg white solution under an alkaline condition and a step of performing hydrolysis with a protease.

### BACKGROUND ART

Egg white has good amino acid balance and contains a quality protein efficiently used in the body. Egg white in a dried form or a raw form is blended into many health foods to adjust nutritional ingredients, for example. Egg white hydrolysates obtained by hydrolyzing egg white with a protease sometimes exhibit functions not achieved by the ingredient raw egg white. Thus, effective use of egg white hydrolysates has been investigated.

For example, an oil-and-fat composition that contains a polyunsaturated fatty acid and exhibits excellent oxidation stability due to an antioxidant effect of an egg white hydrolysate (Patent Literature 1), a seasoning agent having an antioxidative potency (Patent Literature 2), and an enzyme hydrolysate of egg white having a blood-pressure-lowering effect (Patent Literature 3) have been proposed. There is high expectation for new ways to effectively utilize egg white hydrolysates.

Examples of a method for producing a protein hydrolysate include a method in which a protein is hydrolyzed with hydrochloric acid and then heated under an alkaline condition (Patent Literature 4) and a method of hydrolyzing a protein with a protease.

However, among proteins, egg white has a unique problem in that it generates a sulfur smell upon being heated and affects the flavor of foodstuffs when used in food. It is also known that the sulfur smell intensifies if egg white is heated in the presence of an alkali. Egg white treated with a protease also generates a sulfur smell due to a subsequent protease deactivation treatment (e.g., 80° C. to 100° C. for 5 to 30 minutes). Thus, the problem remains even when egg white hydrolysates are used in food products.

One known method for improving the flavor of protein hydrolysates is a method with which a milk protein hydrolysate is filtered, heated, treated with activated carbon, and ultrafiltrated (Patent Literature 5). This method can suppress generation of undesirable flavors of the milk protein hydrolysate but cannot reduce the sulfur smell characteristic to egg white.

### CITATION LIST

### Patent Literature

Patent Literature 1: Japanese Unexamined Patent Application Publication No. 2-218796

Patent Literature 2: Japanese Unexamined Patent Application Publication No. 51-61670

Patent Literature 3: Japanese Unexamined Patent Application Publication No. 3-280835

Patent Literature 4: Japanese Patent No. 3419035

Patent Literature 5: Japanese Patent No. 4436961

### SUMMARY OF INVENTION

### Technical Problem

The present invention provides an egg white hydrolysate having a reduced sulfur smell characteristic to egg white and a reduced hydrogen sulfide content, and a method for producing the egg white hydrolysate.

### Solution to Problem

The inventors of the present invention have carried out extensive studies on various conditions such as raw ingredients and processes to address the challenge described above and found that the sulfur smell and the hydrogen sulfide content of an egg white hydrolysate are reduced when an egg white hydrolysate is made through a pretreatment step of denaturing egg white by heating a diluted egg white solution under an alkaline condition and a step of performing hydrolysis with a protease. Thus, the present invention has been made.

In other words, the present invention provides the following:
(1) A method for producing an egg white hydrolysate, the method including a pretreatment step of denaturing egg white by thermally treating a diluted egg white solution under conditions of a pH of 9 to 12 and a temperature of 55° C. to 90° C., the diluted egg white solution having been prepared by diluting 1 part of liquid egg white with 0.4 to 3 parts of water, and a step of performing hydrolysis with a protease.
(2) The method for producing an egg white hydrolysate described in (1), in which the hydrolysis is performed after the pH value of the pretreated diluted egg white solution has been adjusted to be in the range of 6 to 8.
(3) The method for producing an egg white hydrolysate described in (1) or (2), in which the heating temperature in the pretreatment step is in the range of 60° C. to 80° C.
(4) The method for producing an egg white hydrolysate described in any one of (1) to (3), in which the egg white hydrolysate is a soluble egg white hydrolysate.
(5) An egg white hydrolysate having a degree of hydrolysis of to 40, an average molecular weight of 200 to 1500, and a hydrogen sulfide content of 2 ppm or less as measured by the procedure below:

### Procedure

1. Place 3 g of the egg white hydrolysate into a 500 mL Erlenmeyer flask, add 97 g of purified water to the Erlenmeyer flask to dissolve the egg white hydrolysate, and shake the Erlenmeyer flask in a 80° C. constant-temperature oven for 10 seconds.

2. To the Erlenmeyer flask, attach a rubber cap with a glass tube and a gas detector tube inserted therethrough, and allow the lower end of the glass tube to make contact with the liquid surface of the aqueous solution of the egg white hydrolysate.

3. Attach a gas sampler to the gas detector tube, suction 100 mL of gas by using the gas sampler, read the value on the gas detector tube, and assume the reading to be the hydrogen sulfide content.

### Advantageous Effects of Invention

According to the present invention, an egg white hydrolysate having a reduced sulfur smell and a reduced hydrogen sulfide content can be provided and a highly nutritious egg white hydrolysate can be blended into a variety of foodstuffs. Thus, the demand for egg white hydrolysates is expected to increase further.

### DESCRIPTION OF EMBODIMENTS

The present invention will now be described in detail. For the purposes of the present invention, “%” means “% by mass” and “parts” means “parts by mass”. For the sake of convenience, a representative example of a production method according to the present invention is described first.

### 1. Method for Producing an Egg White Hydrolysate

A method for producing an egg white hydrolysate according to the present invention is characterized by including a pretreatment step of denaturing egg white by thermally treating a diluted egg white solution under conditions of a pH of 9 to 12 and a temperature of 55° C. to 90° C., the diluted egg white solution having been prepared by diluting 1 part of liquid egg white with 0.4 to 3 parts of water, and a step of performing hydrolysis with a protease.

### 1.1. Pretreatment Step

Because the method for producing an egg white hydrolysate according to the present invention includes the pretreatment step of denaturing egg white by thermally treating a diluted egg white solution under conditions of a pH of 9 to 12 and a temperature of 55° C. to 90° C., the diluted egg white solution having been prepared by diluting 1 part of liquid egg white with 0.4 to 3 parts of water, the sulfur smell of the egg white hydrolysate can be reduced.

Examples of egg white that can be used as an ingredient in the present invention include not only raw egg white obtained by breaking open poultry eggs such as hen eggs and removing the egg yolks but also desugared egg white obtained by desugaring raw egg white with a yeast, bacterium, or enzyme, concentrated egg white obtained by treating egg white by reverse osmosis or ultrafiltration, and dried egg white obtained by spray-drying or freeze-drying. Among these, desugared egg white is preferably used since browning can be prevented.

For the purposes of the present invention, the term “liquid egg white” refers to egg white that has the same water content (typically 88%) as raw egg white and may refer to dried egg white or concentrated egg white reconstituted by using water so as to have the same water content as raw egg white.

The desugared egg white preferably contains 0.4 mg/mL or less and more preferably 0.2 mg/mL or less of free glucose. The concentration (mg/mL) of free glucose discussed here represents the mass (mg) of free glucose contained in egg white (mL) having a solid matter concentration of 12%.

The concentration of free glucose can be measured with a Medisafe Reader GR-101 (produced by Terumo Co.) and a Medisafe Tip MS-GC25 (blood glucose test measurement tip) (produced by Terumo Co.). In particular, the tip is attached to the Medisafe Reader and egg white having a solid matter concentration of 12% is applied to the tip to measure the concentration of the free glucose. Alternatively, the free glucose concentration may be determined by using urine sugar test paper such as HI-TESPER G Eiken (produced by Eiken Chemical Co., Ltd.).

The amount of water added to prepare the diluted egg white solution described in the present invention is 0.4 to 3 parts, preferably 0.6 to 2.5 parts, and more preferably 0.8 to 2 parts per part of liquid egg white. In the case where the amount of water added is less than 0.4 parts per part of liquid egg white, the egg white will solidify when heated and may not become hydrolyzed with a protease described below. In the case where the amount of water added is more than 3 parts per part of liquid egg white, the yield may decrease and it may take more operation cost to dry the egg white hydrolysate after hydrolysis.

The pH in the pretreatment step is 9 to 12, preferably 9.5 to 11.5, and more preferably 10 to 11. At a pH less than 9, the sulfur-smell-reducing effect of the present invention is not achieved. At a pH exceeding 12, the egg white will solidify when heated and may not become hydrolyzed with a protease described below. Moreover, the sulfur smell may intensify compared to when the pH is 12 or less. The pH of the egg white hydrolysate can be adjusted by, for example, using an alkaline aqueous solution (for example, sodium hydroxide, potassium hydroxide, or sodium carbonate).

The heating temperature in the pretreatment step is 55 to 90° C., preferably 60 to 85° C., and more preferably 65 to 75° C. At a heating temperature lower than 55° C., the sulfur-smell-reducing effect of the present invention is not achieved. At a heating temperature exceeding 90° C., the egg white will solidify when heated and may not become hydrolyzed with a protease described below. Moreover, the sulfur smell may intensify compared to when the heating temperature is 90° C. or lower.

The heating time in the pretreatment step may be any length of time during which the egg white can be appropriately denatured and may be selected from the range of 3 to 60 minutes.

1.2. Step of Performing Hydrolysis with a Protease

The method for producing an egg white hydrolysate according the present invention includes a step of performing hydrolysis with a protease after the pretreatment step described above. As a result, the sulfur smell of the egg white hydrolysate can be reduced.

The method for producing an egg white hydrolysate according to the present invention is preferred since the effect of reducing the sulfur smell of the egg white hydrolysate can be enhanced by first adjusting the pH of the pretreated diluted egg white solution to have a pH of 6 to 8 and then hydrolyzing the pretreated solution with a protease. The pH of the egg white hydrolysate can be adjusted by, for example, using an acidic aqueous solution (e.g., hydrochloric acid or phosphoric acid).

The protease used in hydrolysis is not particularly limited. Examples of the protease include animal-derived proteases such as pepsin, chymotrypsin, trypsin, and pancreatin, plant-derived proteases such as papain, bromelain, and ficin, and endoproteases and exoproteases derived from microorganisms (lactic acid bacteria, Bacillus subtilis, actinomycetes, fungi, yeast, etc.), crude products thereof, and cell homogenates thereof. These can be used alone or in combination.

In the case where hydrolysis is performed after the pH of the pretreated diluted egg white solution is adjusted to be in the range of 6 to 8, a neutral protease among these proteases is preferably used in the present invention to hydrolyze the egg white and to efficiently carry out the reaction. A neutral protease from Bacillus sp. or a neutral protease from Aspergillus sp. may be used as the neutral protease. Examples of commercially available products of a neutral protease from Bacillus sp. include Protease S “Amano” (trade name) (a protease from Bacillus stearothermophilus produced by Amano Enzyme Inc.) and Protease N “Amano” G (trade name) (a protease from Bacillus subtilis produced by Amano Enzyme Inc.). Examples of commercially available products of a neutral protease from Aspergillus sp. include Protease A “Amano” G (trade name) (a protease from Aspergillus oryzae produced by Amano Enzyme Inc.), Sumizyme FP (trade name) (a protease from Aspergillus oryzae produced by Shinnihon Chemicals Corporation), and Dentyne AP (trade name) (a protease from Aspergillus oryzae produced by Nagase Chemtex Corporation).

Hydrolysis of egg white with a neutral protease is described below as an example of a method for hydrolyzing proteins with a protease. A pretreated diluted egg white solution is adjusted to a pH in the range of 6 to 8. A neutral protease is added to the egg white and a temperature in the range of 35° C. to 60° C. and preferably 40° C. to 55° C. is held for 5 minutes to 24 hours while slow stirring is performed. Next, the solution is heated to deactivate the protease. As a result, an egg white hydrolysate of the present invention can be obtained. The egg white hydrolysate obtained is filtered to remove insoluble matter and a soluble egg white hydrolysate is obtained. A soluble egg white hydrolysate is preferable since it has a wide range of uses. If needed, the hydrolysate may be dried by spray drying, freeze drying, or the like.

The temperature condition and the heating time are preferably appropriately adjusted in accordance with the types and combination of the proteases used.

### 2. Egg White Hydrolysate

The egg white hydrolysate obtained by the production method described above has a degree of hydrolysis of 5 to 40 and an average molecular weight of 200 to 1500. The hydrogen sulfide content measured by the procedure described below is 2 ppm or less.

### 2.1. Degree of Hydrolysis

The degree of hydrolysis of the egg white hydrolysate according to the present invention is a value measured by a formol titration method.

That is, first, an egg white hydrolysate is analyzed by a semimicro Kheldahl method to determine the total nitrogen content of the egg white hydrolysate. The egg white hydrolysate is then analyzed by a formol titration method to determine the amino nitrogen content (%) in the egg white hydrolysate. The amino nitrogen content is divided by the total nitrogen content and the result is assumed to be the degree of hydrolysis (%).

The egg white hydrolysate according to the present invention has a degree of hydrolysis of 5 to 40, preferably 7 to 20, and more preferably 9 to 15.

If the degree of hydrolysis of the egg white hydrolysate is higher than the aforementioned value, an aqueous solution prepared from the egg white hydrolysate is likely to contain precipitates or become clouded, which is not preferable. If the degree of hydrolysis of the egg white hydrolysate is lower than the aforementioned value, the bitterness and umami flavor resulting from amino acids become intense, which is also not preferable.

### 2.2. Average Molecular Weight

In the present invention, the average molecular weight of the egg white hydrolysate is a value measured by the following TNBS (2,4,6-trinitrobenzenesulfonic acid) method.

That is, 126 mg of sodium nitrite is accurately weighed and dissolved in purified water. To the resulting solution, 100 mg of sodium 2,4,6-trinitrobenzenesulfonate dihydrate accurately weighed is added to obtain exactly 200 mL of a TNBS reagent. Then 0.4 g of the egg white hydrolysate (product of the invention) is accurately weighed and dissolved in purified water to prepare exactly 100 mL of an aqueous solution. Then 2 mL of this solution is accurately weighed and purified water is added thereto to prepare exactly 100 mL of a sample solution. Next, 0.656 g of L-leucine dried in advance at 105° C. for 3 hours is accurately weighed and dissolved in purified water to prepare exactly 500 mL of an aqueous solution. To exactly 1 mL, 2 mL, 3 mL, and 4 mL of this 500 mL of the solution, purified water is added to prepare reference solutions each exactly 100 mL in volume.

Into test tubes, 0.5 mL of purified water (control), 0.5 mL of the sample solution, and 0.5 mL of each reference solution are respectively weighed and added. To each test tube, 2 mL of a 0.1 mol/L borate buffer solution is added. Then the TNBS reagent is added to each test tube and the mixture is stirred and mixed. Then the test tubes are left to stand in a 37° C. constant-temperature water bath for 2 hours.

Then absorbance at a wavelength of 420 nm is measured with a spectrophotometer. The difference between the observed absorbance and the absorbance of the control obtained from the purified water by the same procedure is assumed to be the absorbance of the sample solution. Similarly, the difference between the absorbance of each reference solution and the absorbance of the control is determined. Then the absorbances are plotted against L-leucine concentration calculated on a dry basis (μmol L-leucine equivalent/mL) to prepare a graph with a vertical axis indicating the absorbance and a horizontal axis indicating the L-leucine concentration. The amino nitrogen concentration (μmol L-leucine equivalent/mL) of the sample solution is determined from the intersection between the absorbance of the sample solution and the straight line (calibration curve) connecting the points of the references.

The amino nitrogen concentration determined here is substituted into the following formula to calculate the amino nitrogen content (mmol L-leucine equivalent/100 g) of the sample.

Amino nitrogen content=amino nitrogen concentration of sample solution×{(100×100)/(amount (g) of sample taken×2)}×10⁻³×100

The total protein content (%) of the egg white used as the raw ingredient of the egg white hydrolysate of the present invention is determined (normally about 11%), and substituted into the following formula so as to calculate the average molecular weight of the egg white hydrolysate.

Average molecular weight=total protein content/amino nitrogen content×1000

The egg white hydrolysate according to the present invention has an average molecular weight of 200 to 1500, preferably 400 to 1200, and more preferably 600 to 1000.

When the average molecular weight of the egg white hydrolysate is higher than the aforementioned value, a large amount of insoluble matter may be generated during production of the egg white hydrolysate and the yield tends to be low, which is not preferable. When the average molecular weight of the egg white hydrolysate is lower than the aforementioned value, the bitterness and umami flavor resulting from amino acids become intense, which is also not preferable.

### 2.3. Hydrogen Sulfide Content

In the present invention, the hydrogen sulfide content of the egg white hydrolysate is a value measured with a gas detector tube measurement system. The gas detector tube measurement system is stipulated in JIS K0804 and includes a detector tube-type gas sampler and a detector tube.

Specifically, 3 g of the egg white hydrolysate is placed in a 500 mL Erlenmeyer flask, 97 g of purified water is added thereto to dissolve the egg white hydrolysate, and the resulting solution is shaken in a 80° C. constant-temperature oven for 10 seconds. A rubber cap with a glass tube and a gas detector tube (“gas detector tube No. 4LB hydrogen sulfide” produced by Gastec Corporation) inserted therethrough is attached to the Erlenmeyer flask so that the lower end of the glass tube makes contact with the liquid surface of the aqueous solution of the egg white hydrolysate. A gas sampler (“gas sampler GV-100” produced by Gastec Corporation) is attached to the gas detector tube and 100 mL of gas is suctioned by using the gas sampler. The value on the gas detector tube is read and assumed to be the hydrogen sulfide content.

The egg white hydrolysate according to the present invention has a hydrogen sulfide content of 2 ppm or less, preferably 1 ppm or less, and more preferably 0.5 ppm or less. The sulfur smell may intensify when the hydrogen sulfide content in the egg white hydrolysate exceeds 2 ppm.

Since the hydrogen sulfide content of the egg white hydrolysate according to the present invention is 2 ppm or less and the sulfur smell is reduced, a highly nutritious egg white hydrolysate can be blended into a wide variety of foodstuffs.

The present invention will now be specifically described on the basis of Examples and Test Examples which do not limit the scope of the present invention.

### EXAMPLES

### Example 1

A diluted egg white solution obtained by diluting 1 part of raw egg white with the same quantity of water was adjusted to have a pH of 10.5 with an aqueous sodium hydroxide solution and pretreated by being heated at 70° C. for 30 minutes. The pretreated diluted egg white solution was adjusted to have a pH of 7.0 with an aqueous hydrochloric acid solution and 2000 units of a neutral protease (Sumizyme FP produced by Shinnihon Chemicals Corporation) was added thereto. Then hydrolysis was performed at 40° C. for 6 hours and the protease was deactivated by being heated at 90° C. for 15 minutes. As a result, an egg white hydrolysate of the present invention was obtained. The egg white hydrolysate obtained was filtered to remove insoluble matter and a soluble egg white hydrolysate according to the present invention was obtained.

The egg white hydrolysate and soluble egg white hydrolysate obtained were eaten. The sulfur smell thereof was sufficiently reduced.

The average molecular weight of egg white in the diluted egg white solution after the pretreatment was 45,000, indicating that the egg white was not hydrolyzed by the pretreatment. The degree of hydrolysis of the soluble egg white hydrolysate obtained was 10.4, the average molecular weight was 840, and the hydrogen sulfide content was 0.2 ppm.

### Comparative Example 1

A soluble egg white hydrolysate was obtained as in Example except that the pretreatment step of the method for producing a soluble egg white hydrolysate of Example 1 was omitted.

In particular, a diluted egg white solution obtained by diluting 1 part of raw egg white with the same quantity of water was adjusted to have a pH of 7.0 with an aqueous hydrochloric acid solution and 2000 units of a neutral protease (Sumizyme FP produced by Shinnihon Chemicals Corporation) was added thereto. Then hydrolysis was performed at 40° C. for 6 hours and the protease was deactivated by being heated at 90° C. for 15 minutes. The egg white hydrolysate obtained was filtered to remove insoluble matter and a soluble egg white hydrolysate was obtained. The sulfur smell of the soluble egg white hydrolysate obtained was evaluated but the sulfur smell was negligibly reduced. The degree of hydrolysis of the soluble egg white hydrolysate obtained was 12.4, the average molecular weight was 700, and the hydrogen sulfide content was 2.8 ppm.

### Test Example 1

A soluble egg white hydrolysate was obtained as in Example 1 except that the amount of water used to prepare the diluted egg white solution in the pretreatment step, the pH in the pretreatment step, the heating temperature, and the pH in the step of performing hydrolysis with a protease in the method for producing a soluble egg white hydrolysate in Example 1 were changed as shown in Table 1.

The effect of reducing the sulfur smell of the soluble egg white hydrolysate obtained and the yield of the soluble egg white hydrolysate were evaluated based on the criteria below.

The degree of hydrolysis, the average molecular weight, and the hydrogen sulfide content of the soluble egg white hydrolysate obtained were measured. The results are shown in Table 1.

### Evaluation of “Sulfur Smell of Soluble Egg White Hydrolysate”

Rank: criterion

A: Sulfur smell of the soluble egg white hydrolysate was sufficiently reduced.

B: Sulfur smell of the soluble egg white hydrolysate was moderately reduced.

C: Sulfur smell of the soluble egg white hydrolysate was negligibly reduced.

### Evaluation of “Yield of Soluble Egg White Hydrolysate”

Rank: criterion

A: High

B: Low

C: Not recovered

TABLE 1

| | Pretreatment step | | | | Evaluation | | | | |
|---|---|---|---|---|---|---|---|---|---|
| | Amount of water | | | | | | | | Hydrogen |
| | added per part | | Heating | Hydrolysis | | | | Average | sulfide |
| | of liquid egg | | temperature | step | Sulfur | | Degree of | molecular | content |
| Sample | white (part) | pH | (° C.) | pH | smell | Yield | hydrolysis | weight | (ppm) |
| No. 1 | 0.3 | 10.5 | 65 | 7 | — | C | — | — | — |
| No. 2 | 0.5 | 10.5 | 65 | 7 | A | B | — | — | — |
| No. 3 | 1 | 10.5 | 65 | 7 | A | A | — | — | — |
| No. 4 | 2 | 10.5 | 65 | 7 | A | A | — | — | — |
| No. 5 | 3 | 10.5 | 65 | 7 | A | B | — | — | — |
| No. 6 | 1 | 8.5 | 65 | 7 | C | A | 10 | 870 | 2.4 |
| No. 7 | 1 | 9 | 65 | 7 | B | A | 10.2 | 860 | 3.2 |
| No. 8 | 1 | 9.5 | 65 | 7 | B | A | 10.7 | 820 | 2.2 |
| No. 9 | 1 | 10 | 65 | 7 | A | A | — | — | — |
| No. 10 | 1 | 11 | 65 | 7 | A | A | 9 | 970 | 0 |
| No. 11 | 1 | 12 | 65 | 7 | A | B | 3.4 | 2570 | 0 |
| No. 12 | 1 | 12.5 | 65 | 7 | — | C | — | — | — |
| No. 13 | 1 | 10.5 | 50 | 7 | C | A | 8.6 | 1020 | 2.3 |
| No. 14 | 1 | 10.5 | 55 | 7 | B | A | — | — | — |
| No. 15 | 1 | 10.5 | 75 | 7 | A | A | — | — | — |
| No. 16 | 1 | 10.5 | 95 | 7 | A | B | 9.7 | 900 | 0.2 |
| No. 17 | 1 | 10.5 | 95 | 7 | — | C | — | — | — |
| No. 18 | 1 | 10.5 | 65 | 8.5 | A | A | 8.4 | 1040 | 0.6 |
| No. 19 | 1 | 10.5 | 65 | 7.5 | A | A | — | — | — |
| No. 20 | 1 | 10.5 | 65 | 6.5 | A | A | — | — | — |
| No. 21 | 1 | 10.5 | 65 | 5.5 | C | B | 7.6 | 1150 | 2.4 |

According to Table 1, the sulfur smell was reduced and the hydrogen sulfide content was 2 ppm or less in the soluble egg white hydrolysates (Sample Nos. 2 to 5, 7 to 11, 14 to 16, and 18 to 20) in which the amount of water added per part of liquid egg white to prepare a diluted egg white solution in the pretreatment step was 0.4 to 3, the pH in the pretreatment step was 9 to 12, and the heating temperature was 55° C. to 90° C.

In particular, the sulfur smell was significantly reduced in the soluble egg white hydrolysates (Sample Nos. 3, 4, 9, 10, 15, and 18 to 20) in which the amount of water added per part of liquid egg white was 0.6 to 2.5 parts, the pH in the pretreatment step was 9.5 to 11.5, and the heating temperature was 60° C. to 80° C.

In a sample (No. 1) in which the amount of water added per part of liquid egg white was less than 0.5 parts, a sample (No. 12) in which the pH in the pretreatment step exceeded 12, and a sample (No. 17) in which the heating temperature was higher than 90° C., egg white was denatured excessively in the pretreatment step and egg white hydrolysates could not be recovered.

### Comparative Example 2

A soluble egg white hydrolysate was obtained as in Example 1 except that the order of the pretreatment step and the hydrolysis step in the method for producing a soluble egg white hydrolysate of Example 1 was reversed.

In particular, a diluted egg white solution obtained by diluting 1 part of raw egg white with the same quantity of water was adjusted to have a pH of 7.0 with an aqueous hydrochloric acid solution and 2000 units of a neutral protease (Sumizyme FP produced by Shinnihon Chemicals Corporation) was added thereto. Then hydrolysis was performed at 40° C. for 6 hours. The hydrolyzed diluted egg white solution was adjusted to have a pH of 10.5 with an aqueous sodium hydroxide solution and then heated at 65° C. for 30 minutes. The protease was then deactivated by heating at 90° C. for 15 minutes. Insoluble matter was removed by filtration and a soluble egg white hydrolysate was obtained.

The sulfur smell of the soluble egg white hydrolysate obtained was evaluated but the sulfur smell was negligibly reduced. The hydrogen sulfide content of the soluble egg white hydrolysate obtained was 2.2 ppm.

1. A method for producing an egg white hydrolysate, the method comprising a pretreatment step of denaturing egg white by thermally treating a diluted egg white solution under conditions of a pH of 9 to 12 and a temperature of 55° C. to 90° C., the diluted egg white solution having been prepared by diluting 1 part of liquid egg white with 0.4 to 3 parts of water, and a step of performing hydrolysis with a protease.

2. The method for producing an egg white hydrolysate according to claim 1, wherein the hydrolysis is performed after the pH value of the pretreated diluted egg white solution has been adjusted to be in the range of 6 to 8.

3. The method for producing an egg white hydrolysate according to claim 1, wherein the heating temperature in the pretreatment step is in the range of 60° C. to 80° C.

4. The method for producing an egg white hydrolysate according to claim 1, wherein the egg white hydrolysate is a soluble egg white hydrolysate.

5. An egg white hydrolysate having a degree of hydrolysis of 5 to 40, an average molecular weight of 200 to 1500, and a hydrogen sulfide content of 2 ppm or less as measured by the procedure below:
Procedure
1. Place 3 g of the egg white hydrolysate into a 500 mL Erlenmeyer flask, add 97 g of purified water to the Erlenmeyer flask to dissolve the egg white hydrolysate, and shake the Erlenmeyer flask in a 80° C. constant-temperature oven for 10 seconds.
2. To the Erlenmeyer flask, attach a rubber cap with a glass tube and a gas detector tube inserted therethrough, and allow the lower end of the glass tube to make contact with the liquid surface of the aqueous solution of the egg white hydrolysate.
3. Attach a gas sampler to the gas detector tube, suction 100 mL of gas by using the gas sampler, read the value on the gas detector tube, and assume the reading to be the hydrogen sulfide content.

6. The method for producing an egg white hydrolysate according to claim 2, wherein the heating temperature in the pretreatment step is in the range of 60° C. to 80° C.

7. The method for producing an egg white hydrolysate according to claim 2, wherein the egg white hydrolysate is a soluble egg white hydrolysate.

8. The method for producing an egg white hydrolysate according to claim 3, wherein the egg white hydrolysate is a soluble egg white hydrolysate.
